(19) United States
(12) Patent Application Publication
(10) Pub. No.: US 2009/0144832 A1
(43) Pub. Date: Jun. 4, 2009

(54) METHOD FOR PROTECTING CONTENT AND METHOD FOR PROCESSING INFORMATION

(75) Inventors: Sung Hyun CHO, Seoul (KR); Min Gyu CHUNG, Seoul (KR); Koo-yONG PAK, Seoul (KR); Il Gon PARK, Seoul (KR); Man Soo JEONG, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/266,993

(22) Filed: Nov. 7, 2008

Related U.S. Application Data
(63) Continuation of application No. 12/298,913.
(60) Provisional application No. 60/885,748, filed on Jan. 19, 2007.
(60) Provisional application No. 60/886,130, filed on Jan. 23, 2007.
(60) Provisional application No. 60/887,949, filed on Feb. 2, 2007.
(60) Provisional application No. 60/889,794, filed on Feb. 14, 2007.
(60) Provisional application No. 60/890,269, filed on Feb. 16, 2007.
(60) Provisional application No. 60/891,275, filed on Feb. 23, 2007.
(60) Provisional application No. 60/894,050, filed on Mar. 9, 2007.
(60) Provisional application No. 60/980,452, filed on Oct. 17, 2007.

(51) Int. Cl. G06F 17/00

(52) U.S. Cl. 726/26

(57) ABSTRACT

Disclosed are a method of protecting content and a method of processing information. The method of protecting content can include service related information including revocation application information of content from the outside by employing a content management and protection system, and apply or not apply a content revocation process on the content according to the revocation application information. Accordingly, whether to apply a content revocation process can be controlled according to revocation application information.

### CROSS-REFERENCE TO RELATED APPLICATIONS

This application is a continuation of U.S. application Ser. No. 12/298,913, filed Oct. 29, 2008, now pending, which is a 371 of International Application No.: PCT/KR2008/000378, filed Jan. 21, 2008, which claims priority from U.S. Provisional Application 60/885,748 filed on Jan. 19, 2007, U.S. Provisional Application No. 60/886,130 filed on Jan. 23, 2007, U.S. Provisional Application No. 60/887,949 filed on Feb. 2, 2007, U.S. Provisional Application No. 60/889,794 filed on Feb. 14, 2007, U.S. Provisional Application No. 60/890,269 filed on Feb. 16, 2007, U.S. Provisional Application No. 60/891,275 filed on Feb. 23, 2007, U.S. Provisional Application No. 60/894,050 filed on Mar. 9, 2007, U.S. Provisional Application No. 60/980,452 filed on Oct. 17, 2007 all of which are incorporated by reference.

### TECHNICAL FIELD

The present invention relates to a method of protecting content and a method of processing information, and more particularly, to content protection and information processing technologies which can control whether or not to perform a content revocation process by employing revocation application information included in a specific information signal received from the outside.

### BACKGROUND ART

In recent years, as the commercialization of wired/wireless Internet, the intelligence and networking of home appliances, and so on are carried out, digital convergence, which creates new types of services through the convergence of different digital services, has been accelerated. Digital convergence provides service providers with an opportunity to create new profits and expand business and also users with user-oriented services that are able to satisfy complicated and diversified needs. In line with such digital convergence, the existing broadcasting services have changed to various types of digital broadcasting services by expanding their areas to content services through wired/wireless networks. Digital broadcasting can provide a good quality of broadcasting content through a wired network or a wireless network and also provide an expanded concept of services through association with digital home environments, etc. A representative example of the expanded concept of service may include a content sharing service, etc., in which broadcasting content is stored using a personal recorder, and the like and then moved to another devices for use purpose within digital home environments.

However, for the purpose of this content sharing service, and the like, there is a need for a security system capable of preventing illegal use or export of content. In particular, it is necessary to consistently protect content in local areas, such as digital home environments, because broadcasting content is out of the protection range of a security system for content protection when the broadcasting content is transmitted upon content sharing (for example, a CAS (Conditional Access System)).

Accordingly, there have recently been proposed content protection management systems, which can consistently protect pertinent content when broadcasting content is stored in digital home environments, personal recorders, and so on. Active research has been done on technologies which can support the content protection management systems, such as technologies related to content handling, license creation and management, domain management, revocation application and process, etc.

### DISCLOSURE

### Technical Problem

A technical object of the present invention is to provide a technology, which can control whether or not to apply a content revocation process based on revocation application information input from the outside through a specific information signal.

### Technical Solution

To achieve the above technical object, the present invention provides a method of protecting content in an aspect. The content protection method may include the steps of receiving revocation application information from an external system, deciding a revocation process mode based on the revocation application information, and mapping revocation information based on the revocation process mode in order to distribute the content to devices on a domain corresponding to an internal system.

To achieve the above technical object, the present invention provides a method of protecting content in another aspect. The content protection method may include the steps of creating revocation application information based on a content attribute, and transmitting the revocation application information so that distribution of the content is controlled based on the revocation application information. Here, a revocation process mode may be decided based on the revocation application information, and the revocation information may be mapped based on the revocation process mode.

To achieve the above technical object, the present invention provides a method of protecting content in still another aspect. The content protection method may include the steps of receiving content distributed based on revocation information, and using the content according to previously set authority information. Here, the revocation information may be mapped based on a revocation process mode and the revocation process mode may be based on revocation application information.

To achieve the above technical object, the present invention provides a method of processing information in further still another aspect. The information processing method may include the steps of, in a method of processing information employing a content management and protection system, receiving service related information, including revocation application information of content, from the outside, and applying or not applying a content revocation process on the content according to the revocation application information. Here, the service related information may be received in the form of a FTA (Free To Air) broadcasting signal.

The revocation application information may be set to any one of a first value, indicating that the content revocation process should not be applied, and a second value, indicating that the content revocation process should be applied.

When the revocation application information is set to the first value, the step of applying or not applying the content revocation process may include the step of setting specific information, which is included in a content license associated with the content, to a specific value on which the content revocation process is not applied. At this time, the specific information may be a revocation list index list associated with the content.

Meanwhile, the information processing method may further include the steps of receiving external content, receiving a great number of information related to the external content, converting the external content into content that can be managed and protected in the content management and protection system, and creating a content license associated with the content by employing the great number of information related to the external content.

Here, the great number of information may include content management and protection information including usage rules information for protecting and managing the content within the content management and protection system, the service related information including generic content protection information for a content providing service, and revocation related information for prohibiting the content from being used in unauthorized devices.

The content management and protection information may include at least any one of copy and movement control information for controlling the copy and movement of content, consumption control information for controlling the consumption of content, propagation control information for controlling content propagation between devices within a domain, output control information for controlling the output of content, and ancillary control information of content.

The content license may include at least any one of content license identification information including information for identifying the content license, content license creator information including information for identifying a creator that has created the content license, compliance/robustness regime information indicating a compliance/robustness regime associated with the content, revocation information associated with the content, authorized domain identification information including identification information of an authorized domain in which the content can be used, descrambling information of the content, and the content management and protection information.

The revocation information may include a list of a revocation list index. Here, the revocation index may be numeric information that is increased by a specific value whenever a new revocation list is issued.

### ADVANTAGEOUS EFFECTS

As described above, according to the present invention, whether or not to apply a content revocation process can be controlled according to revocation application information input through a specific information signal (i.e., a FTA broadcasting signal) from the outside. In particular, the content revocation process may not be applied to specific content based on the revocation application information. Accordingly, content such as urgent messages and public notices, which should be seen by anyone without limitation to devices or domains, can be utilized easily when the content is transmitted.

### DESCRIPTION OF DRAWINGS

FIG. 1 is a block diagram schematically showing the concept of a CMP (Content Management and Protection) system;

FIG. 2 is a conceptual view illustrating a function construction of a CMP module shown in FIG. 1;

FIG. 3 is an exemplary view illustrating the format of a CMP content license; and

FIG. 4 is a flowchart illustrating a method of processing information in accordance with a preferred embodiment of the present invention.

### DESCRIPTION OF REFERENCE NUMERALS OF PRINCIPAL ELEMENTS IN THE DRAWINGS

CD: CMP device
CM: CMP module
10: acquisition module
20: storage module
30: processing module
40: consumption module
50: export module

### MODE FOR INVENTION

Hereinafter, the present invention will be described in detail in connection with preferred embodiments with reference to the accompanying drawings in order for those skilled in the art to be able to implement the invention. In the preferred embodiments of the present invention; specific technical terminologies are used for clarity of the content. However, It is to be understood that the present invention is not limited to specific selected terminologies and each specific terminology includes all technical synonyms operating in a similar way in order to accomplish a similar object.

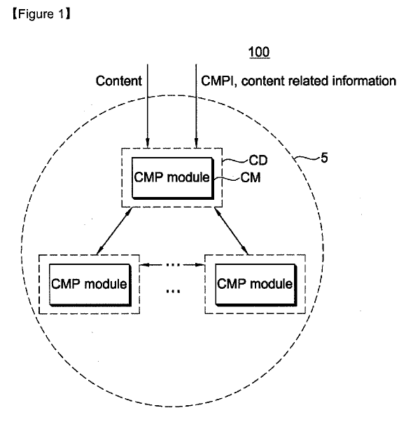

FIG. 1 is a block diagram schematically showing the concept of a CMP system.

As shown in FIG. 1, a CMP system 100 forms a domain 5. The domain 5 is a collection of authorized CMP devices (CDs) and can refer to a region whose reliability for the legal use of content is guaranteed. Content can be moved and used between CMP devices (CDs) registered with the domain 5 within an authorized authority range. This domain 5 can be implemented in a local environment such as a digital home environment.

The CMP device (CD) may refer to a device equipped with a CMP module (CM). The CMP module (CM) functions to protect and manage content input from the outside to the CMP system 100. For example, the CMP module (CM) can convert content, which is input to the CMP system 100, into a specific type of content, for example, CMP content and can generate a specific type of a CMP content license through which the CMP content can be used. The CMP module (CM) can also protect and manage generated CMP content by controlling the use of the CMP content based on a CMP content license.

The CMP device (CD) can receive content, CMP information (hereinafter abbreviated as CMPI) associated with the content, various pieces of content related information associated with the content, and so on through a wireless network, a wired network or a storage medium. The information can be transmitted to a CMP device (CD) through each defined format, root, and channel.

The CMPI may refer to usage rules information for protecting and managing CMP content in the CMP system 100.

The CMPI can include copy and movement control information for controlling the copy and movement of CMP content, consumption control information for controlling the consumption of CMP content, propagation control information for controlling the propagation of CMP content between CMP devices within a domain, output control information for controlling the output of CMP content, ancillary control information of CMP content, and so on.

The content related information can include service related information, revocation related information, Compliance/Robustness Regime (hereinafter, referred to as C/R regime) related information; etc. of content.

The service related information may refer to generic content protection information for a content providing service. This content service related information can be transmitted from a service provider to a CMP device in the form of a FTA (Free to Air) broadcasting signal. The service related information can include revocation application information, information to indicate whether or not to perform scrambling, remote access control information, and the like.

The revocation related information includes information for preventing content from being used in fraudulent devices, unauthorized devices, etc. For example, the revocation related information can include a revocation list (hereinafter abbreviated as RL) or RL related information. The revocation related information can be transmitted from a service provider side, a server for CMP revocation management, etc. to a CMP device (CD).

The C/R regime related information may refer to information pertinent to policy application rules with respect to content on the service provider side. This C/R regime related information can include information of a C/R regime of a content protection system applied to content, for example, CA (Conditional Access) or DRM (Digital Rights Management). The C/R regime related information can be transmitted from a service provider side, a content protection system service, etc. to a device.

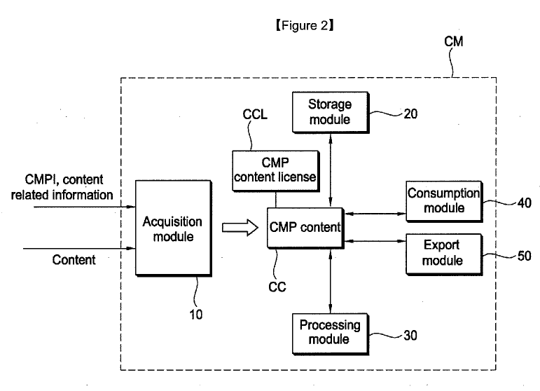

FIG. 2 is a conceptual view illustrating a function construction of the CMP module shown in FIG. 1.

The CMP module (CM) can include, as shown in FIG. 2, an acquisition module 10, a consumption module 40, an export module 50, a storage module 20, and a processing module 30. The acquisition module 10, the consumption module 40, and the export module 50 can have the concept of a point at which access to the outside exists, and the storage module 20 and the processing module 30 can have the concept of an internal entity.

The acquisition module 10 functions to convert content and content related information, which are input from the outside to the CMP system 100, into a type that can be used within the CMP system 100.

For example, the acquisition module 10 can receive content transmitted from the outside, scramble the received content in a form defined in the CMP system 100, and convert the scrambled content into CMP content (CC). The CMP content (CC) may refer to content of a type that can be protected and managed under the CMP system 100. The acquisition module 10 also generates a CMP content license (CCL) for using CMP content (CC) using externally received CMPI information and content related information.

Content transmitted from the outside to a CMP device (CD) can be clean content, which is received through a trusted transmission method with guaranteed reliability, or scrambled content, which is protected by a content protection system with guaranteed reliability, for example, a CAS or DRM system. In the latter case, pertinent content can be received by a CMP device (CD), scrambled through a CAS module or a DRM module (existing outside the CMP module) included in the CMP device (CD), converted into the form of clean content, and then transmitted to the acquisition module 10. Here, a key for scrambling the content can be obtained by performing an ECM (Entitle Control Message)/EMM (Entitlement Management Message) process on content related information associated with the content.

Meanwhile, a CMP content license (CCL) generated by the acquisition module 10 is bound so that it is associated with corresponding CMP content (CC). At this time, the CMP content license (CCL) can be included in the CMP content (CC) in an embedded form or a form separated from the CMP content (CC).

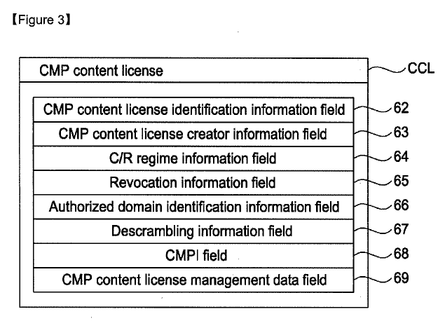

FIG. 3 is an exemplary view illustrating the format of the CMP content license (CCL).

The CMP content license (CCL) can include, as shown in FIG. 3, a CMP content license identification information field 62, a CMP content license creator information field 63, a C/R regime information field 64, a revocation information field 65, an authorized domain identification information field 66, a descrambling information field 67, a CMPI field 68, a CMP content license management data field 69, and so on.

The CMP content license identification information field 62 is a field into which CMP content license identification information is inserted. The CMP content license identification information may refer to unique identification information for identifying a corresponding CMP content license.

The CMP content license creator information field 63 is a field into which CMP content license creator information for identifying a creator who has created a CMP content license (CCL) is inserted. For example, the CMP content license creator information may refer to identification information of a CMP module (CM) that has created a corresponding CMP content license (CCL).

The C/R regime information field 64 is a field into which C/R regime information associated with a corresponding CMP content (CC) is inserted. Here, the C/R regime information may refer to information for identifying a C/R regime associated with the CMP content (CC).

The C/R regime may refer to a policy rule of a service provider side or a content protection system (for example, a CAS or DRM) with respect to content. A plurality (for example, eight) of the C/R regimes may be associated with one CMP content (CC). In other words, a plurality of different policy rules defined on the service provider side can be applied to one CMP content (CC). The C/R regime information can be configured to include plural bits, which can be set to, for example, ‘1’ or ‘0’, and to identify a C/R regime(for example, RL) associated with CMP content.

The revocation information field 65 is a field into which revocation information of a corresponding CMP content (CC) is inserted. The revocation information includes information on which a RL, including information of a CMP device (or a CMP module) or a domain that limits the use of a corresponding CMP content (CC), can be found.

For example, the revocation information may refer to a RL index list. Here, the revocation information field of the RL index can include a RL index list (i.e., the list of RL indices). Here, the RL index is information included in a RL to identify the RL. For example, the RL index is a number that is increased by 1 whenever a new RL is issued. In other words, the RL index may refer to information for identifying the most recently issued RL. The RL index list is the list of RL indices and helps to find the most recent RL when using CMP content. Meanwhile, if it is not necessary to apply a RL when using content, the RL in RL index list can be set to, for example, ‘0’.

The authorized domain identification information field 66 is a field into which domain identification information is inserted. The domain identification information may refer to identification information of a domain 5 in which CPM content can be used. If CPM content (CC) can be used without limitation to the range of the domain 5, the domain identification information can be set to, for example, ‘0’.

The descrambling information field 67 is a field into which descrambling information of CMP content (CC) is inserted. The descrambling information can include information about a scrambler that has scrambled the CMP content (CC), descrambling key information, and so on.

The CMPI field 68 is a field into which CMPI is inserted. The CMPI may refer to usage rules information for protecting and managing CMP content (CC) within the CMP system 100. As mentioned earlier, the CMPI can include copy and movement control information, consumption control information, propagation control information, output control information, ancillary control information, etc. of CMP content (CC).

The CMP content license management data information field 69 is a field into which CMP content license management data information is inserted. The CMP content license management data information field 69 can include length information of a CMP content license (CCL), information about an issuer who has issued CMP content license (CCL) finally (for example, certificate information, etc. of a CMP module that has issued a CMP content license finally), and so on.

The information included in the CMP content license (CCL) can be used as license information for controlling use authority of content when the functions of the consumption module 40, the export module 50, the storage module 20, and the processing module 30 are performed on the content.

The consumption module 40 functions to consume CMP content (CC), such as playing CMP content (CC) through sound or video or outputting CMP content (CC) via a digital or analog interface. For example, in order to consume CMP content (CC), the consumption module can extract a descrambling key from a CMP content license (CCL), descramble the CMP content (CC), decode the CMP content (CC), and then output the decoded CMP content (CC), or convert decoded content into analog information and then output or play the converted content. This consumption of the CMP content (CC) can be controlled according to consumption control information, output control information, etc., which are included in CMPI of a CMP content license (CCL).

The export module 50 can function to export CMP content (CC) to another CMP device. In order to export CMP content (CC), not only control information included in CMPI of a CMP content license (CCL), but also C/R regime information, revocation information, and the like of a CMP content license (CCL) can be considered. For example, if the export of specific CMP content (CC) is permitted in control information of CMPI, but is not authorized in C/R regime information, etc., the content may not be exported.

The storage module 20 can function to store CMP content (CC) in a CMP device (CD). This storage of CMP content (CC) can be controlled according to copy and movement control information, and so on which are included in CMPI of a CMP content license (CCL).

The processing module 30 can function to process CMP content (CC). For example, the processing module 30 can perform a function of trans-coding CMP content (CC) into content with a different compressed format, video resolution, video frame rate, and audio sampling rate, a function of applying video or audio effects, a function of inserting selective data or content factors, a function of extracting still images from video streams, and so on.

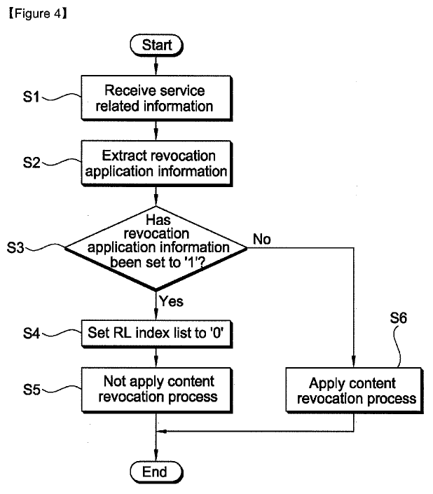

FIG. 4 is a flowchart illustrating a method of processing information in accordance with a preferred embodiment of the present invention. This drawing shows a process of determining whether or not to apply a RL according to revocation application information, which is included in service related information of content and received.

Referring to FIG. 4, a CMP device can receive service related information of content from the outside (step: S1). For example, the CMP device can receive a FTA broadcasting signal from a service provider side. The service related information can include revocation application information, information to indicate whether or not to perform scrambling, remote access control information, and so on.

The revocation application information is information to indicate whether or not to apply a content revocation process for content. Here, the content revocation process may refer to a process of prohibiting access to a device (or a CMP module) or a domain, which exists in a revocation list associated with a corresponding CMP content, by checking the revocation list upon access to a corresponding CMP content.

This revocation application information can be information of 1 bit, which is set to a specific value, for example, a first value (in the present embodiment, it is assumed to be ‘1’) or a second value (in the present embodiment, it is assumed to be ‘0’). Here, when the revocation application information is set to ‘1’, it may indicate that the content revocation process should not be applied, and when the revocation application information is set to ‘0’, it may indicate that the content revocation process should be applied.

Meanwhile, a CMP module can convert content into CMP content and create a CMP content license associated with the CMP content.

The CMP module that has received the service related information extracts revocation application information included in the service related information (step: S2) and then determines whether the extracted revocation application information is set to a first value (for example, ‘1’) or a second value (for example, ‘0’) (step: S3).

If the revocation application information is set to the first value, the CMP module sets specific information of the CMP content license to information, indicating that the content revocation process should not be applied. For example, if the revocation application information is set to the value ‘1’ indicating that the content revocation process should not be applied, the CMP module can set revocation information (i.e., a RL index list) of the CMP content license to ‘0’ (step: S4). Accordingly, the content revocation process is not applied since the RL index list is set to ‘0’ when using the CMP content (step: S5).

On the other hand, when the revocation application information is set to the second value, the CMP module does not need to perform a special setting process since the content revocation process has to be performed normally. In this case, the list of RL indices is included in the revocation information (i.e., the RL index list) of the CMP content license. Accordingly, when performing the content revocation process, the CMP module can perform the revocation process by finding requested RL in the RL index list (step: S6).

As described above, the application of the content revocation process to specific content can be prohibited according to revocation application information transmitted through the FTA broadcasting signal. This processing procedure can be utilized when transmitting content, which should be seen by anyone without limitation to devices or domains, such as urgent messages and public notices.

Meanwhile, the information, which is included in the service related information and indicates whether or not to perform scrambling, may refer to information indicating whether or not to apply scrambling for the purpose of content protection when creating CMP content. For example, the information indicating whether or not to perform scrambling may be information of 1 bit, which is set to a specific value, for example, ‘1’ or ‘0’. Here, when the information indicating whether or not to perform scrambling is set to ‘1’, it may indicate that scrambling of content should not be performed, and when the information indicating whether or not to perform scrambling is set to ‘0’, it may indicate that scrambling of content should be performed.

The information indicating whether or not to perform scrambling may be inserted into a specific field (for example, an ancillary control information insert field) of CMPI of a CMP content license, which is associated with a pertinent content.

Further, the remote access control information included in the service related information may refer to control information used to prevent unauthorized redistribution of content. This remote access control information may be information of 2 bits, which can be set to four kinds of values, for example, ‘0’, ‘1’, ‘2’ and ‘3’. For example, ‘0’ may indicate that remote access is permitted through an Internet or another transmission network, and ‘1’ to ‘3’ may indicate that strict remote access is required step by step.

This scrambling remote access control information can be inserted into a specific field of CMPI of a CMP content license associated with a pertinent content (for example, a specific field of propagation control information).

Hereinafter, a process of applying revocation when a service provider, for example, a broadcasting station propagates content to a CMP device and the CMP device distributes the content to another CMP device within a domain (referred to as an end point device) is described.

The broadcasting station first creates revocation application information, indicating whether or not to apply revocation on a specific content. Here, the broadcasting station can create revocation application information based on an attribute of the content. For example, it is preferred that information, such as an urgent message, be viewed in all devices without applying a revocation process. Thus, the broadcasting station can create revocation application information, including information to indicate that revocation information should not be applied.

Thereafter, the broadcasting station can transmit the revocation application information to a CMP device through, for example, a FTA signal. The CMP device can receive the revocation application information, and apply or not apply a revocation process for the use of a pertinent content according to an instruction of the revocation application information.

For example, the CMP device can receive the revocation application information and decide a revocation process mode based on the revocation application information. In order to distribute content to other devices of a domain, the CMP device can map the revocation information based on the revocation process mode. Here, when the revocation process mode indicates an application mode, the CMP device can map the revocation information so that the export of content is restricted based on previously set revocation information. When the revocation process mode indicates a non-application mode, the CMP device can map the revocation information so that the export of content is not restricted based on previously set revocation information. Upon mapping, the CMP device can map the revocation information per on a list basis. For example, the CMP device can map the revocation information per on a revocation-list basis based on the revocation process mode. Further, an attribute of the revocation application information can be based on at least one of content and a device and can be one-time and non one-time. When the attribute is non one-time, the CMP device can store the revocation application information.

Meanwhile, an end point device can receive content, which is distributed based on revocation information, from the CMP device and use the content according to previously set authority information. Here, the revocation information can be mapped based on a revocation process mode and the revocation process mode can be based on revocation application information.

Although the present invention has been described in connection with the embodiment of the present invention illustrated in the accompanying drawings, it is not limited thereto. It will be apparent to those skilled in the art that various substitutions, modifications and changes may be made thereto without departing from the scope and spirit of the invention.

What is claimed is:

1. A computer-implemented method comprising:
receiving scrambling application data indicating whether to apply a scrambling process to content;
mapping the scrambling application data to a table that indicates a usage status of the content; and
determining whether to apply the scrambling process to the content according to the scrambling application data.

2. The method of claim 1, wherein receiving scrambling application data indicating whether to apply a scrambling process to content further comprises:
receiving the scrambling application data over free-to-air broadcast signals.

3. The method of claim 1, wherein the scrambling application data comprises first or second values indicating that the scrambling process should not or should be applied, respectively.

4. The method of claim 3, wherein mapping scrambling application information to a table further comprises setting a specific parameter in the table to specific value based on the scrambling application data.

5. The method of claim 1, wherein a license of the content comprises the table.

6. A device comprising:
an interface configured to receive scrambling application data indicating whether to apply a scrambling process to content; and
a processor configured to:
map the scrambling application data to a table that indicates a usage status of the content, and
determine whether to apply the scrambling process to the content according to the scrambling application data.

7. The device of claim 6, wherein receiving scrambling application data indicating whether to apply a scrambling process to content further comprises:
receiving the scrambling application data over free-to-air broadcast signals.

8. The device of claim 6, wherein the scrambling application data comprises first or second values indicating that the scrambling process should not or should be applied, respectively.

9. The device of claim 8, wherein mapping scrambling application information to a table further comprises setting a specific parameter in the table to specific value based on the scrambling application data.

10. The device of claim 6, wherein a license of the content comprises the table.

11. A system comprising:
one or more computers;
a computer-readable medium coupled to the one or more computers having instructions stored thereon which, when executed by the one or more computers, cause the one or more computers to perform operations comprising:
receiving scrambling application data indicating whether to apply a scrambling process to content,
mapping the scrambling application data to a table that indicates a usage status of the content, and
determining whether to apply the scrambling process to the content according to the scrambling application data.

12. The system of claim 11, wherein receiving scrambling application data indicating whether to apply a scrambling process to content further comprises:
receiving the scrambling application data over free-to-air broadcast signals.

13. The system of claim 11, wherein the scrambling application data comprises first or second values indicating that the scrambling process should not or should be applied, respectively.

14. The system of claim 13, wherein mapping scrambling application information to a table further comprises setting a specific parameter in the table to specific value based on the scrambling application data.

15. The system of claim 11, wherein a license of the content comprises the table.
